(19) United States
(12) Patent Application Publication
(10) Pub. No.: US 2016/0303404 A1
(43) Pub. Date: Oct. 20, 2016

(54) SYSTEM FOR RECHARGING PORTABLE BREATHING APPARATUS

(71) Applicant: STORK TECHNICAL SERVICES (RBG) LIMITED, Aberdeen (GB)

(72) Inventor: James Roddy Elliott, Aberdeen (GB)

(73) Assignee: STORK TECHNICAL SERVICES (RBG) LIMITED, Aberdeen (GB)

(21) Appl. No.: 15/102,171

(22) PCT Filed: Dec. 4, 2014
(86) PCT No.: PCT/GB2014/053600

§ 371 Date: Jun. 6, 2016

(30) Foreign Application Priority Data
Dec. 6, 2013 (EP) 13275302.1

(51) Int. Cl. A62B 7/02; A62B 25/00; A62B 9/02

(52) U.S. Cl. CPC A62B 7/02; A62B 9/02; A62B 25/00

(57) ABSTRACT

A system (1) for recharging portable breathing apparatus, said system comprising a supply of high pressure air (2), a plurality of portable recharging stations (7), each recharging station being connected to the supply of air via an air delivery line (9), a valve portion (18) mounted within a handle (19) on each portable recharging station, said portion being connectable to a corresponding valve portion (17) on a portable breathing apparatus (25) in a push fit manner.

The present invention relates to a system for recharging portable breathing apparatus and more particularly to a portable system which can be deployed in hazardous and/or hostile environments such as for example within a structure such as the leg of an oil or gas platform in an offshore or onshore location or the tank of a vessel such as an oil or gas delivery vessel where personnel may need to be located for extended periods to carry out tasks including maintenance and repair work.

Personnel working in hazardous environments are often called upon to undertake tasks which require the use of portable breathing apparatus. For example in an oil or gas offshore platform, inspection or maintenance work may be required to be carried out internally within one or more of the legs of the platform. This can involve a team of workers having to be deployed to the required location within the leg and having to carry out the inspection or repair in difficult to reach areas.

Due to the materials which are present in the environment where the work is being done, portable breathing apparatus is often needed, both to allow the personnel to get to the required location, and also to allow the personnel to remain safely in location and carrying out the inspection or repairs as required. In the event of an emergency, the personnel have to be able to be safely recovered from the working location. It is possible that the recovery operation could take longer than the supply of air in the portably breathing apparatus used by the team of workers.

Backup systems must be provided to assist in the safe withdrawal in emergency situations. One option is for personnel to carry replacement canisters of air which can be used should the main working tank become depleted. A second option is to deploy additional backup canisters around the working location which can be accessed by personnel.

In a known system, a supply of replacement air canisters are deployed into the working environment in advance of the personnel being sent in. The replacement air canisters are typically mounted within a cradle or support frame which itself must be deployed into the environment. This may for example require the cradle to be lowered into a platform leg, or carried into the hull of a vessel. In either case, where space is at a premium and the working conditions are compromised due to the hazardous materials which are present, not only at the required work site where the cradle will be located, but also on the way to and from the site. For example walkways and ladders may be coated with a film of oil or water which can create a further hazard to be negotiated.

The cradle carries a plurality of air canisters which can be picked up by personnel and used to replace an empty air canister in the portable breathing apparatus. However, replacement of an air canister may involve a number of intricate steps including disconnecting the empty canister, temporarily connecting the breathing apparatus to a secondary air supply at high pressure, such as an air supply line which is lowered into the leg, removing the empty canister from the holder carried by the user, swapping the empty canister for a full canister from the cradle and reconnecting the breathing apparatus to the full canister. The environment within the leg of an oil or gas platform is typically very dark and dirty and the risk of contamination of the valves of the air lines is high when these are being swapped over in these conditions. The user must complete a set of delicate connections and disconnections whilst his hands, which are typically gloved, may be covered in oily water or other substances which will make the operation difficult and time consuming.

Each canister of air may provide up to 10 minutes of air for the user and so this operation of swapping out used canisters may have to occur many times during any recovery or escape procedure.

Furthermore, providing secondary air supply lines into the local environment for each of the workers in the team provides a further hazard as these lines can become snagged on features within the leg of the platform such as ladders which can interrupt the air flow. Additionally, the lines themselves represent a hazard to the workers as they have to avoid tripping on them in an already crowded and difficult work space.

The present invention therefore seeks to address these issues and provide a system for recharging portable breathing apparatus which can be deployed into a hazardous working environment to allow work to be safely carried out, and then recovered from the environment for deployment elsewhere.

According to one aspect of the present invention there is provided a system for recharging portable breathing apparatus, said system comprising a supply of high pressure air, a plurality of portable recharging stations, each recharging station being connected to the supply of air via an air delivery line, a valve portion mounted within a handle on each portable recharging station, said portion being connectable to a corresponding valve portion on a portable breathing apparatus in a push fit manner.

Advantageously the supply of high pressure air is provided at approximately 220 bar up to a maximum of approximately 300 bar.

As the valve portion on the recharging station is mounted within a handle, the user can grip the handle and push the corresponding valve portion attached to their portable breathing apparatus into the handle in a simple operation to connect the flow of air through the portable recharging station to a tank of their portable breathing apparatus. This avoids the need to connect different air lines to the valve on their portable tank and also prevents the respective valve portions on the recharging station and the portable breathing apparatus from becoming contaminated from materials within the environment where the user is working.

Preferably the handle comprises a cylindrical body within which the valve portion is mounted.

Advantageously the cylindrical body has a radially extending flange at either end.

Preferably the handle is connected to the portable recharging station via a flexible air line.

The flanges at either end of the body mitigate against the handle sliding out of the user's hand and thus provide further protection against contamination entering the valve. The handle will be easily grasped by the operator. As the valve portion is encased within the handle, this means that the operator can grasp the handle without touching the valve portion and so avoids dirt, oil, grease or other contaminants from fouling the valve. Furthermore, as the handle is easy to hold, even with wet or slippery hands or gloves, the valve connection can be made more securely, safely and more quickly, especially in an emergency situation when the worker is moving from recharging station to recharging station and refilling his portable air tank at each successive station he encounters.

Preferably the air supply is provided by a bank of air at 220 bar and the air supply further comprises a compressor to supply air to the various recharging stations remotely from the air supply.

Preferably each air delivery line comprises a high pressure air line.

Advantageously the air line is mounted on a reel within or adjacent to the air supply. Preferably the air line comprises a plurality of modular sections connected together with a valve at the connection points.

Advantageously a refill station is connected to the air line via a further length of air hose, through the valve.

The length of the air line is dependent upon the number of recharging stations provided with the system.

In some examples 120 m of air line is provided on the reel.

An embodiment of the present invention will now be described with reference to and as shown in the accompanying drawings in which:

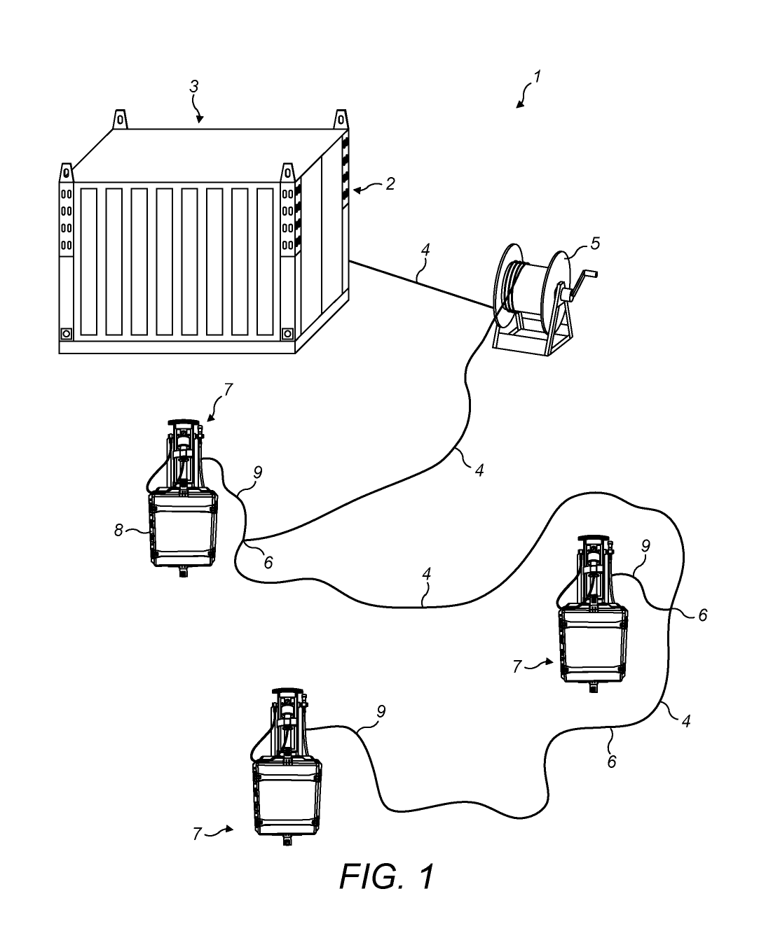

FIG. 1 is a schematic view of a system for recharging portable breathing apparatus according to one aspect of the present invention;

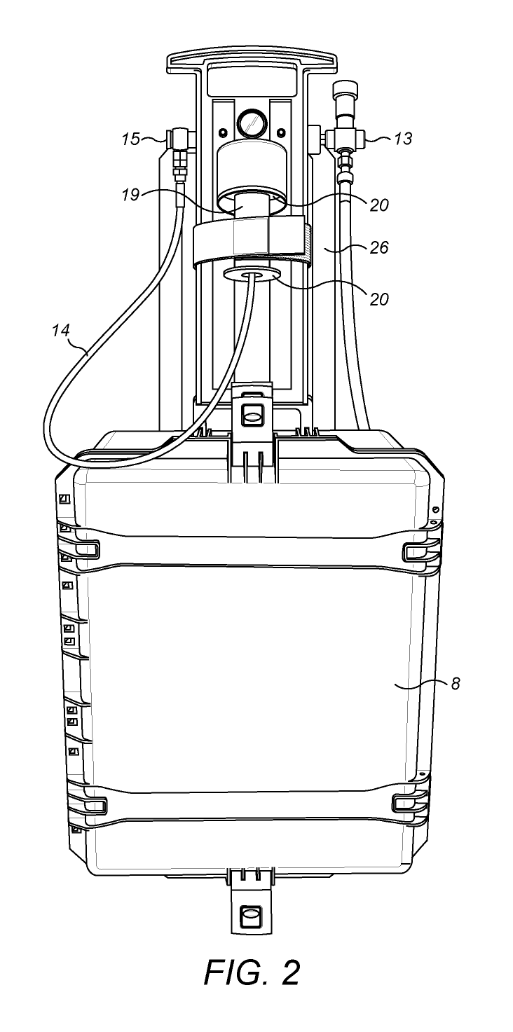

FIG. 2 is a schematic view of a recharging station of the system of FIG. 1;

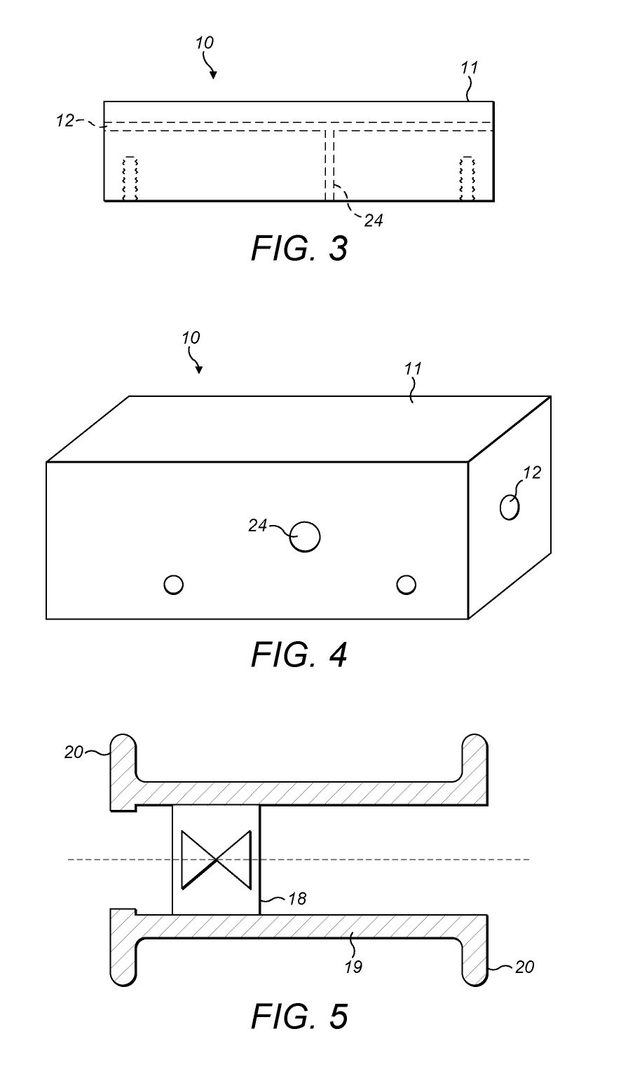

FIG. 3 is a cross sectional view through a manifold of the recharging station of FIG. 2;

FIG. 4 is a schematic perspective view of the manifold of FIG. 3;

FIG. 5 is a cross sectional view through a handle of the recharging station of FIG. 2;

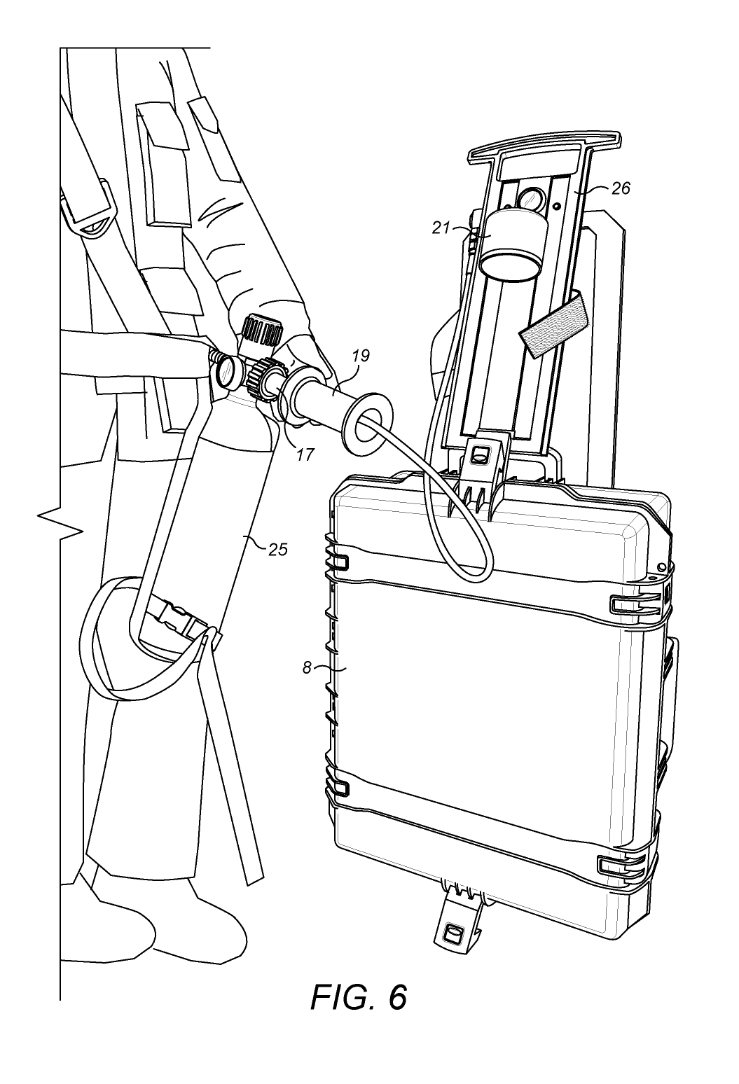

FIG. 6 is an illustration of an operator using a recharging station, and

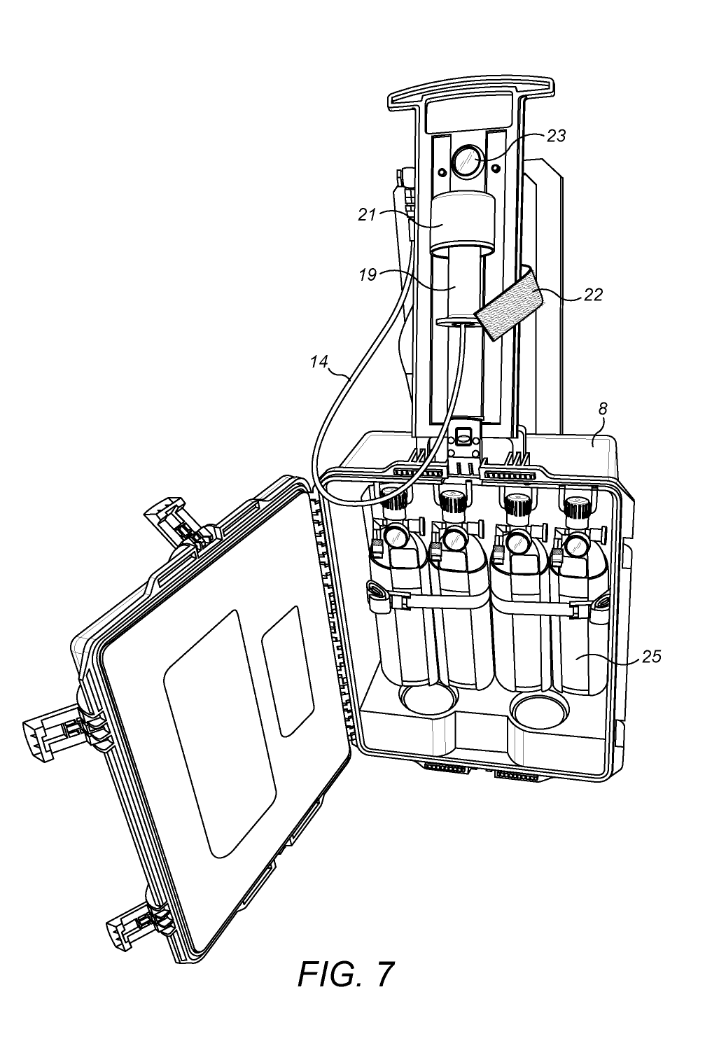

FIG. 7 is a schematic view of a recharging station of FIG. 1 in an open condition.

Turning now to the drawings, there is shown in FIG. 1 a system 1 for recharging portable breathing apparatus according to one embodiment of the present invention.

The system is described below as mounted on an oil or gas production platform for providing air to workers operating within a leg of the platform, although it is envisaged that the system could be provided in other locations or areas as will be described further below.

The system comprises a supply of high pressure air 2. This is shown in FIG. 1 as a tank or container 3 which is mounted either on the surface of or in another suitable location on an oil or gas platform. In use the system may comprise an air supply and a compressor (not shown) to provide air at a constant pressure of 220 bar although the precise technical specifications for the air supply and the components required to provide such a constant supply will be within the remit of the skilled person. A high pressure hose 4 is connected to an outlet from the air supply. The hose may be wound onto a reel 5 which may be mounted internally of the container or alternatively may be mounted externally and preferably adjacent to the container.

In the present embodiment, the hose 4 is a commercially available high pressure airline. The hose comprises a plurality of sections of air line which are connected together via valves 6 to allow additional lines to be teed into the main hose. In the present embodiment the hose is formed of 10 m lengths of air line connected together via the valves, although this length may be altered to suit different work environments, say to 20 meter lengths or some other suitable figure. Each valve is capped off to prevent air from escaping from the line.

The hose 4 extends from the air supply 2 to the location within the leg of the platform where inspection or maintenance work is to be carried out. The leg of the platform is divided into a number of horizontal levels with working platforms provided at each and an internal staircase or ladder connecting each level with the levels immediately above and below.

In this embodiment a recharging station 7 is provided at each working platform within the leg, however the recharging stations may be spaced out between various working platforms as required in accordance with health and safety provisions based on the time taken for a worker to climb from one platform to another.

Each recharging station comprises a portable container 8 which can be located at a safe and accessible point on the working platform. The high pressure hose 4 extends from the air supply on the surface of the platform to the working location and each recharging station 7 is connected into the high pressure air line through a short length of high pressure air hose 9 which connects through a valve 6 between two adjacent lengths of hose line.

The container 8 of each recharging station comprises a hollow shell which can be utilised to hold an emergency backup supply of air tanks which can be used by a worker in an emergency situation, such as where the high pressure air line connecting the various recharging stations together is severed or otherwise blocked as shown in FIG. 7.

The upper portion of the recharging station comprises a stainless steel manifold 10 (shown in FIGS. 3 and 4). The manifold comprises a solid block 11 with an internal horizontal bore 12 extending from a first (system) end to a second (operator) end of the manifold. The length of high pressure air hose 9 connecting the recharging station to the high pressure air line is connected through a valve 13 to the manifold at the system end.

Additional bores may be provided in the manifold to facilitate mounting to the recharging station.

A non return valve (not shown) is provided between the first end of the manifold and the high pressure air supply, for example in the high pressure air hose connecting the recharging station to the high pressure air line as will be described further below.

A flexible hose 14, preferably a metal hose, is mounted to the second (operator/personnel) end of the manifold through a swivel fitting 15. This allows the orientation of the flexible hose to be altered without damage to the hose at the point of connection to the manifold as will be described further below.

Each recharging station carries part of a high pressure, quick connect valve system which, when connected to a cooperating part of the valve system carried on the worker's portable breathing apparatus, allows a worker to recharge the air tank of his portable breathing apparatus at any of the recharging stations. The cooperating valve system 16 may comprise male 17 and female 18 valve portions. In the present embodiment the female valve portion is a valve socket mounted on the recharging station and the male valve portion is a cooperating valve plug provided on the portable breathing apparatus and preferably on the portable air canister carried by the operator.. However, in other embodiments the mounting male and female valve portions may be reversed with the male valve portion carried on the recharging station and the female valve portion carried on the canister of the portable breathing apparatus.

The valve portion on the recharging stations is mounted within a hollow cylindrical handle 19 provided at the free end of the flexible hose 14 on the recharging station. The handle is shown in cross section in FIG. 5 and has radially extending flanges 20 at either end. This allows the operator to securely grasp the handle, even when wearing gloves that may be wet and slippery from oil or other contaminants. The handle portion is formed of aluminium and in the present embodiment the handle portion is finished in a red anodised coating to provide a visual pointer to the handle for the user. The female valve portion is preferably mounted within the handle, adjacent to one of the radial flanges and the male valve portion can be pushed securely into the female valve portion in a simple and efficient push fit operation.

A cradle or docking station 21 may be provided on the exterior of the container 8 of the recharging station to allow the handle to be securely mounted in an accessible location for the user when not in use and to prevent damage to the flexible hose 14 between the recharging station and the handle and also to prevent ingress of contaminants into the valve portion within the handle. The docking station may cover the open end of the handle in which the female valve portion is mounted when the handle is stowed.

In some embodiments a further restraining means may be provided on the recharging station to hold the handle in the required position ready for use. The restraining means may be a releasable strap 22 for example in the form of a strip of resilient material such as rubber (not shown). One end of the rubber strip may be secured to one side of the recharging station. An aperture is provided adjacent the other end of the rubber strip and a spigot or spar may be mounted on the other side of the recharging station, remote from the fixing point of the rubber strip. This allows the rubber strip to be stretched across the front of the recharging station and retained in the closed position by cooperation of the spar in the aperture in the free end of the strip. When the handle is to be released, the free end of the strip can be grasped and pulled off the spar to release the handle from the front of the recharging station.

A pressure gauge 23 is mounted on the recharging station to provide information to the user on the pressure of air passing through the manifold. A bore 24 is drilled into the manifold between a front portion and the through bore 12 to connect the gauge to the air supply passing through the manifold.

In preparation for an inspection or maintenance programme to be carried out, the high pressure air supply unit 2 is mounted in an accessible, but convenient location, preferably adjacent to the hatch or entry point through which workers will pass to gain access to the location where work is to be carried out but out of the way to allow access for personnel and equipment to pass into and out of the entry point. An appropriate number of recharging stations 7 are carried to convenient locations between the air supply and the work location. For example in the leg of an oil platform, recharging stations may be placed at each working platform level within the leg. The recharging stations may, in some cases, be carried to the working platforms by personnel on fixed line breathing apparatus to ensure that they can be recovered from the location safely in the event of an emergency.

The high pressure hose 4 is connected at one end to the high pressure air supply and reeled out from the storage reel 5, past each of the recharging stations as required. Prior to mounting the hose on the reel, sections of hose are measured out and connected together through tee valves 6 and caps (not shown) are placed on the valves. The length of each section of hose is selected to substantially match the distance between the recharging stations such that each recharging station can be connected into the high pressure hose at a tee valve by removing the cap on the valve and connecting a short hose from the recharging station to the high pressure hose. Any tee valves that are not in use will remain covered by their respective caps to keep them free from contamination from the environment.

Once in position and teed into the high pressure air line, the recharging stations 7 are ready for use by personnel to recharge their portable breathing apparatus used either to safely make their way to the required work location, or to work within the desired location or both.

As an inspection team or work over team operate their portable breathing apparatus, the air in the portable canisters 25 is gradually used up. In order to top up the air in a portable canister, the user moves to the closest recharging station 7. This may require a short climb or decent on internal ladders or over existing equipment, however the modular nature of the system ensures that the recharging stations will have been located at suitable positions in order to limit the distance and time that any user will be from at least one if not more of the recharging stations.

Upon approaching the recharging station, the user does not have to remove the portable air canister 25 which he is wearing as part of the portable breathing apparatus, nor disconnect the air line between the portable canister and his mask in order to recharge his air supply. He need only remove a cap (not shown) from the end of the quick connect plug portion 17 of the valve mounted on his air canister and upon reaching the recharging station, release the handle 19 portion from the cradle or docking station 21, by releasing the strap if provided, and push the plug portion of the valve into the socket portion 18 within the handle of the recharging station.

As the plug of the valve engages in the valve socket, high pressure air flows from the air supply, through the air line and into the manifold 10 on the system side, through the valve on the operator side of the manifold, along the length of flexible hose 14 between the recharging station and handle, through the push fit valve system 16 and into the portable air canister 25.

The gauge 23 will allow the operator to determine that air is available at the recharging station. The gauge may display information relating to the pressure of air in the manifold in any required way, such as using figures or colours or a combination of both. In some embodiments a digital gauge may be provided and an audible signal may be transmitted when the portable air canister is full.

Additionally, gauges (not shown) are provided on the portable air canisters of the portable breathing apparatus and the operator can visually check that air in the canister is being replenished.

While the recharging operation is underway, the user is still connected via an air hose to the portable canister and can therefore directly breath the air which is being fed into the canister 25 without having to swap over any air lines. The non return valve between the recharging station and the high pressure air supply prevents and flow of air from the canister to the high pressure air supply.

Once the canister is full of air, the user can simply disconnect the push fit valve portions 17,18 by pulling the handle 19 free of the portable canister thereby cutting off further air flow from the recharging station to the canister. A dust cap, which will typically be connected to the canister so that it is quickly and easily located can then be replaced onto the valve on the canister and the handle of the recharging station can be returned to the cradle or docking station 21 and the strap refastened if provided.

The user can then return to work or, if he is in the process of exiting the working area, move to the next recharging station on his way to the surface of the platform.

It will be appreciated that the present invention provides an improved system for enabling workers to recharge their portable breathing apparatus when working in dangerous or otherwise hazardous conditions with the minimum of handling of air lines thus reducing or otherwise preventing contamination of the airlines and providing for secure recharging during emergency situations when the users may be expected to be in a heightened state of tension. Additionally, as the user's hands are likely to be wet or slippery due to the general presence of oil residues in oil or gas platforms, the present system allows the user to securely grasp the handle 19 of the recharging station, even when wearing gloves that can reduce the sensation of touch, and quickly and efficiently connect the valve portions together without risk of damage to the valve through poor or mis-alignment of the valve portions and without any locking procedure which could be difficult to complete in emergency situations. By mounting a portion of the valve within in the handle, this provides the operator with a way of securely holding one part of the push fit valve system while the second part is engaged to open the valve and allow the flow of air. As the air flow is immediately established, this can provide a moment for the operator to assess their situation and location before moving on to the next recharging station or exit point.

FIG. 6 shows an operator adjacent a recharging station with the canister of his portable breathing apparatus connected to the handle of the recharging station such that the valve portions are connected to allow air to flow into the canister.

Where the system is deployed within the leg of an oil platform, users will be able to move between vertical work areas within the platform in a safe and controlled manner in the knowledge that further recharging stations are located at reasonable points on their way towards the exit from the working location. Additionally, in the unlikely event of a malfunction at any of the recharging stations, each station provides a secure container within which a back up supply of air canisters is located, as shown in FIG. 7 which will allow the user to pick up another or a fresh canister in accordance with current operations. This should allow personnel to move to the next recharging station where their canister can be replenished or additional canisters located.

The present invention further provides a modular system which can be built to any required environment and provided for use in any required depth of length as needed. Furthermore, the present invention provides for a system which can be quickly and simply installed into a required location a short time before the work team is deployed to carry out the required inspection or repair as needed. Once the work is completed, the system can then be quickly and simply retrieved by disconnecting the recharging stations from the air line and retrieving them to the surface or entry to the work location. The air line can then be reeled back in and recovered.

A further safety feature may be incorporated into the present invention by mounting a strobe light on the recharging station so that personnel can quickly locate the nearest recharging station to them in the case of an emergency.

The upper portion of the recharging station 26 which carries the manifold, gauge, cradle and handle may be hingedly connected to the container 8 to allow the upper portion to be folded into the interior of the container 8 for storage and deployment to further protect the elements of the recharging station and also to reduce the space required during storage. The container may be provided of a moulded material such as a plastics material and is the general size of a suitcase so easily moved around and lifted from place to place. The container preferably has a handle The canister may comprise a body portion and a door which are hinged together and closed via catches or latches. In preferred embodiments the container 8 is provided on wheels so that it can be easily wheeled from location to location. This greatly enhances the portability of the system and particularly of the recharging stations thus enabling the system to be quickly and easily deployed into and then recovered from the required locations. The container has a handle which is attached to the top portion of the container and which allows the upper portion of the recharging station to be fixed in position against the handle when the upper portion is extended in order for use. For example the handle of the container may be comprise two spaced vertical struts with a horizontal bar stretching between the upper portion of the struts remote from the container. Thus the handle is substantially an inverted U-shape. A pair of latching elements such as C-clips may be mounted on the rear surface of the upper portion which can be engaged with the horizontal bar of the handle to securely hold the upper portion of the recharging station in the required position for use. The block of the recharging station may be mounted on the rear of the upper portion and the latching elements may be provided on the block, thus leaving the ends of the block free for connection of air hoses as noted above.

During use it is possible to relocate the recharging stations should it be considered that they should be closer together, further apart, or additional recharging stations provided. As the recharging stations are portable as part of the system and they are not permanently fixed to the platform floor, it is relatively simple for the operator to design a bespoke system for each location where the system is to be deployed and to use the existing containers with appropriate piping between then.

The present invention is particularly advantageous where the work programme to be carried out is of a short nature such as only a few days as the system does not require permanent mounting of any of the components nor any permanent supply of air to be established. The system can be deployed and recovered from an environment as and when it is required for work to be carried out. In addition, the system provides substantial cost savings as equipment does not have to be permanently deployed into areas where only limited use of the equipment is required.

Whilst the system has been described as deployed within the vertical leg of a platform which requires the descending or ascending of ladders internally of the leg to move between different platforms, the system may also be used within horizontal work spaces such as the tank of a container vessel or FPSO for example. In this case, the bulkheads of the vessel may present dangers to those working within the environment of the tank such as carrying out inspection, repair or cleaning services within the tank.

Typically when working in such tanks each worker is connected into a permanent air line which is deployed into the tank. The air lines themselves may become a danger for other workers and may become entangled or fouled on projections within the vessel hull as the workers move around the tank. The present invention provides for recharging stations to be located at suitable points along the tank of the vessel with a single air line connecting each of the recharging stations to the main air supply. Preferably the recharging station will be located in positions which will ensure that personnel can move between them without crossing over the fixed air line of other personnel in the tank to avoid any entanglement of the air lines. The present invention provides a modular system which can be deployed into such work locations in any suitable layout which can be quickly and easily adapted for the size of the tank, number of operators and scale of the job amongst other things. Thus d the advantages of the recharging stations as previously described can be realised in this alternative working environment.

1. A system for recharging portable breathing apparatus, said system comprising a supply of high pressure air, a plurality of portable recharging stations, each recharging station being connected to the supply of air via an air delivery line, a valve portion mounted within a handle on each portable recharging station, said portion being connectable to a corresponding valve portion on a portable breathing apparatus in a push fit manner.

2. A system according to claims 1, wherein the supply of high pressure air is provided at approximately 220 bar.

3. A system according to claims 2, wherein the supply of high pressure air is provided up to a maximum of approximately 300 bar.

4. A system according to claim 1, wherein the handle comprises a cylindrical body within which the valve portion is mounted.

5. A system according to claim 4, wherein the cylindrical body has a radially extending flange at either end.

6. A system according to claim 1, wherein the handle is connected to the portable recharging station via a flexible hose.

7. A system according to claim 2, wherein the air supply is provided by a bank of air at 220 bar and the air supply further comprises a compressor to supply air to the various recharging stations remotely from the air supply.

8. A system according to claim 1, wherein each air delivery line comprises a high pressure an line.

9. A system according to claim 8 wherein the air line is mounted on a reel within or adjacent to the air supply.

10. A system according to claim 8, wherein the air line comprises a plurality of modular sections connected together with a valve at the connection points.

11. A system according to claim 1 wherein the valve portions comprise a valve plug and a cooperating valve socket which together provide a high pressure quick connect valve.

12. A system according to claim 11, wherein the high pressure, quick connect valve socket is mounted within the handle of the recharging station.

13. A system according to claim 6, wherein the flexible hose is mounted to the recharging station through a swivel fitting.

14. A system for recharging portable breathing apparatus substantially as hereinbefore described with reference to and as shown in the accompanying figures.
